(19) United States
(12) Patent Application Publication
(10) Pub. No.: US 2024/0028881 A1
(43) Pub. Date: Jan. 25, 2024

(54) DEEP NEURAL NETWORK (DNN) COMPUTE LOADING AND TRAFFIC-AWARE POWER MANAGEMENT FOR MULTI-CORE ARTIFICIAL INTELLIGENCE (AI) PROCESSING SYSTEM

(71) Applicant: MEDIATEK INC., Hsinchu (TW)

(72) Inventors: En-Jui CHANG, Hsinchu (TW); Chih-Chung CHENG, Hsinchu (TW)

(73) Assignee: MEDIATEK INC., Hsinchu (TW)

(21) Appl. No.: 18/356,313

(22) Filed: Jul. 21, 2023

Related U.S. Application Data
(60) Provisional application No. 63/368,998, filed on Jul. 21, 2022.

(51) Int. Cl. G06N 3/063; G06N 3/10

(52) U.S. Cl. CPC G06N 3/063; G06N 3/10

(57) ABSTRACT

Aspects of the present disclosure provide a method for controlling a processing device to execute an application that runs on a neural network (NN). The processing device can include a plurality of processing units that are arranged in a network-on-chip (NoC) architecture. For example, the method can include obtaining compiler information relating the application and the NoC, controlling the processing device to employ a first routing scheme to process the application when the compiler information does not meet a predefined requirement, and controlling the processing device to employ a second routing scheme to process the application when the compiler information meets the predefined requirement.

### CROSS-REFERENCE TO RELATED APPLICATIONS

This present application claims the benefit of U.S. Provisional Application No. 63/368,998, “DNN Compute Loading and Traffic-Aware Power Management for Multi-core AI Processing System” filed on Jul. 21, 2022, which is incorporated herein by reference in its entirety.

### TECHNICAL FIELD

The present disclosure relates to neural networks (NNs), and specifically relates to selection of routing schemes for network-on-chip (NoC)-based deep NN (DNN) accelerators.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Network-on-chip (NoC) interconnection is highly flexible and scalable. In order to reduce the design complexity of a deep neural network (DNN) accelerator implementation, an NoC-based DNN design becomes an attractive paradigm.

### SUMMARY

Aspects of the present disclosure provide a method for controlling a processing device to execute an application that runs on a neural network (NN). The processing device can include a plurality of processing units arranged in a network-on-chip (NoC) architecture. For example, the method can include obtaining compiler information relating the application and the NoC, controlling the processing device to employ a first routing scheme to process the application when the compiler information does not meet a predefined requirement, and controlling the processing device to employ a second routing scheme to process the application when the compiler information meets the predefined requirement.

In an embodiment, the predefined requirement can include channel congestion occurring in the NoC. In some embodiments, the compiler information can include bandwidths of channels of the NN and throughput of the NoC. For example, the first routing scheme can include buffer gating control and contention-free switching. As another example, the second routing scheme can include an adaptive routing algorithm.

In an embodiment, the bandwidths of the channels of the NN depend on partitioning of tensor data of the application input to layers of the NN. For example, the tensor data can be partitioned into XY-partition tiles or K-partition tiles.

In an embodiment, the NN can include a deep NN (DNN). In another embodiment, the processing device can be a deep learning accelerator (DLA).

Aspects of the present disclosure also provide an apparatus. For example, the apparatus can include receiving circuitry, a compiler coupled to the receiving circuitry, and a processing device coupled to the compiler. The receiving circuitry can be configured to receive compiler information. The compiler can be configured to determine a routing scheme and generate firmware. The processing device can be configured to execute, based on the firmware, an application that runs on a neural network (NN). The processing device can include a plurality of processing units that are arranged in a network-on-chip (NoC) architecture. For example, the processing device can employ a first routing scheme to process the application when the compiler information does not meet a predefined requirement. As another example, the processing device can employ a second routing scheme to process the application when the compiler information meets the predefined requirement.

Note that this summary section does not specify every embodiment and/or incrementally novel aspect of the present disclosure or claimed invention. Instead, this summary only provides a preliminary discussion of different embodiments and corresponding points of novelty over conventional techniques. For additional details and/or possible perspectives of the present disclosure and embodiments, the reader is directed to the Detailed Description section and corresponding figures of the present disclosure as further discussed below.

### BRIEF DESCRIPTION OF THE DRAWINGS

Various embodiments of this disclosure that are proposed as examples will be described in detail with reference to the following figures, wherein like numerals reference like elements, and wherein:

FIG. 1A is a schematic diagram showing a deep neural network (DNN) that is mapped to a network-on-chip (NoC);

FIG. 1B shows a spatial reuse case of compute units;

FIG. 1C shows a spatiotemporal reuse case of compute units;

FIG. 2 is a schematic diagram showing a local router (LR) of the NoC forwarding packets/flits to a downstream router (DR) of the NoC;

FIG. 3 is a block diagram of an exemplary deep learning accelerator (DLA) core according to some embodiments of the present disclosure;

FIG. 4 is a graph that is used to evaluate the performance of an NoC;

FIG. 5 shows a compiler determining routing schemes and generating corresponding firmware for DLAs to run according to some embodiments of the present disclosure;

FIG. 6 is a flow chart of an exemplary method according to some embodiments of the present disclosure; and

FIG. 7 is a functional block diagram of an exemplary apparatus according to some embodiments of the present disclosure.

### DETAILED DESCRIPTION OF EMBODIMENTS

Neural networks (NNs), e.g., deep neural networks (DNNs) and convolutional neural networks (CNN), have been widely used in a variety of cognitive applications, e.g., pattern recognition, image classification, computer vision, etc., and have achieved remarkable successes in some scenarios where the volume of data that are to be processed far exceeds the capability of human beings, e.g., self-driven cars. The scale of the DNNs is becoming larger and larger, in order to better infer data that are input to the DNNs. For example, current DNN models may consist of hundreds of layers and millions of parameters, e.g., weights, biases, kernels and activation functions, and involve complex vector and matrix computations at each layer. However, too large a DNN model may be too complex to be efficiently run on general hardware platforms. Network-on-chip (NoC), e.g., in the form of mesh, tree and ring, has been widely utilized in modern multi-core systems, e.g., deep learning accelerators (DLAs), for on-chip data transferring, and have provided a flexible, scalable and reusable solution to accelerate the operations of the DNN models.

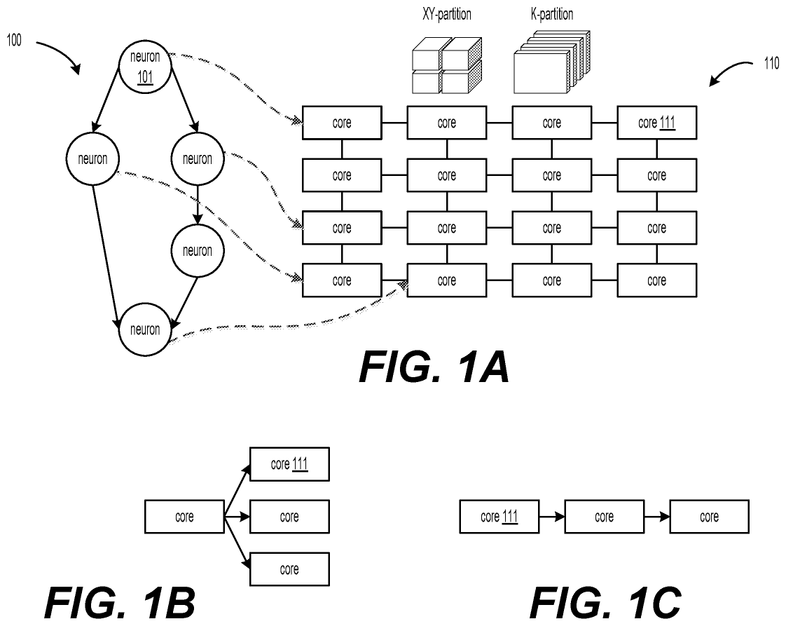

FIG. 1A is a schematic diagram showing a DNN 100, e.g., a CNN, which can be mapped or allocated to an NoC 110. The CNN 100 may consist of a plurality of neurons 101 that are arranged in multiple layers. The tensor data input to the layers can be partitioned into blocks of filters and channels, called tiles, e.g., XY-partition tiles and K-partition tiles. Each of the convolution partitioned tiles requires iterative use of the available compute units, e.g., a spatial reuse case, as shown in FIG. 1B, and a spatiotemporal reuse case, as shown in FIG. 1C.

The NoC 110 is a packet-switched network, which can enable a large number of processing elements (PEs), e.g., the cores 111, to communicate with each other. The NoC 110 may consist of routers and links, where each of the routers can be connected to a PE (or a group of PEs), and links can connect the routers to each other.

The DNN 100 can be mapped to the NoC 110 sequentially and randomly, or by some sophisticated algorithms, e.g., mapping a group of neurons that meet some specific requirements to a PE in order to reduce the overall data communication, packet latency and power consumption.

The tensor data input to the layers can be partitioned into XY-partition tiles and/or K-partition tiles, which may be different in sizes. As a result, the computing loadings of the cores 111 of the NoC 110 may be asymmetric due to different approaches of data tiling and mapping. Therefore, computing power may be wasted on non-critical loads. In average, 85% of the input buffers of the NoC 110 are idle, but still consume power. Besides, as the size of the NoC 110 increases, its network traffic load tends to become unbalanced, due to different approaches of data reuse, causing some routers to become hot-spot nodes.

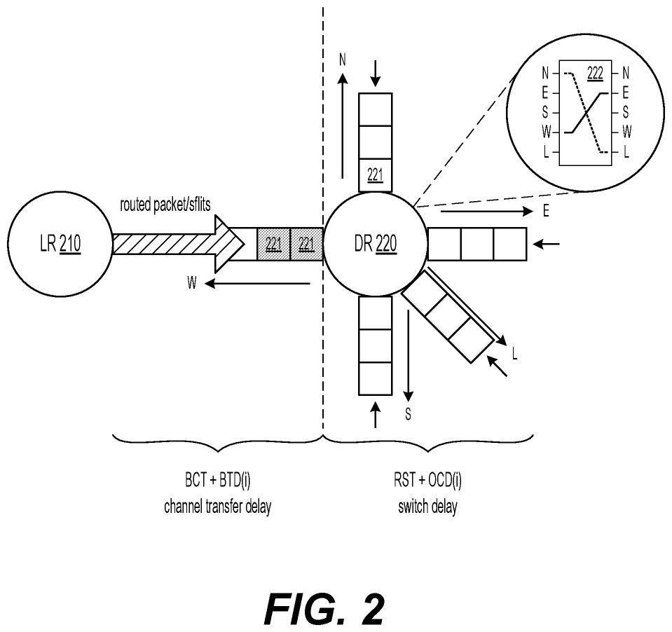

FIG. 2 is a schematic diagram showing a local router (LR) 210, e.g., a router of the NoC 110, forwarding packets/flits to a downstream router (DR) 220, e.g., another router of the NoC 110. In an embodiment, each of the LR 210 and the DR 220 can be modeled as a set of first-come-first-serve input buffers e.g., input buffers 221, a crossbar switch, e.g., a crossbar switch 222, which connect the input buffers 221 to one another, and some other components, e.g., an arbitrator. In an embodiment, the LR 210 and the DR 220 each have one or more ports for receiving flits transferred from other routers that neighbor the LR 210 and the DR 220 in different directions. For example, the input buffers 221 can buffer flits forwarded from upstream routers, e.g., the LR 210, in a plurality of directions, e.g., north N, east E, south S, west W and local L at different ports of the DR 220.

An incoming flit may spend a router latency L(i) on the input buffers 221 and the switch 222. The router latency L(i) is a performance metric that directly reflects the level of congestion. Therefore, by analyzing the router delay L(i), information about the path congestion can be modeled accurately. The input buffers 221 and the switch 222 are prone to congestion, which increases queueing delays in the routing path. Accordingly, the router latency L(i) may consist of two major delays: a channel transfer delay (BCT+BTD(i)) and a switch delay (RST+OCD(i)), and can be expressed by

L(i)=(BCT+BTD(i))+(RST+OCD(i)), where

iϵ{north,east,sourth,west}. (1)

The channel transfer delay (BCT+BTD(i)) is related to the transmission of flits in the input buffers 221, and may consist of a buffer constant time (BCT) and a buffer transfer delay (BTD(i)). The BCT is a constant delay that occurs when a flit is transferred through an empty input buffer 221. The BTD(i) is a time duration that an incoming header experiences during its shift toward the top of the input buffer 221 after flits accumulation. The switch delay (RST+OCD(i)) is related to allocation and switching of flits, and may consist of a router service time (RST) and an output contention delay (OCD). The RST is a constant delay for a router, e.g., the DR 220, processing a flit. The OCD(i) is time of contention with other flits. For example, the OCD(i) is zero if there is no contention, and the switch delay is equal to the RST. The routed flit needs to wait for some flits serviced by the switch 222 and be transferred through the router, e.g., the DR 220, and then the output port of the DR 220 can be released. The OCD(i) can also be treated as the switch waiting time.

The router latency L(i) can reflect how different buffer architectures, allocations, and routing algorithms influence the total path delay of a packet. However, not all parameters are required to be considered when identifying how the selection function affects the packet delay. Assume that all routers are homogeneous; that is, they have the same buffer architecture and switch architecture. Therefore, the BCT and the RST remain unchanged for all routers. If the path congestion occurs, the BTD(i) and the OCD(i) can become a significant part of the overall packet delay. When congestion information is used for selection function, the impacts of the BTD(i) and the OCD(i) shall be considered simultaneously. Therefore, to estimate the congestion level, the BTD(i) and the OCD(i) are analyzed predominantly. Also, the modeling of congestion levels for channels and switches can be discussed, respectively.

As mentioned previously, the BTD(i) is the delay caused by previous flits accumulated on the same input buffer 221. In an embodiment, it is assumed that the flits of different packets are not interleaved; that is, the body flit arrive immediately after the header flit arrives to a port, and the amount of time that the incoming header spends in the input buffer 221 is thus equivalent to the service time of previous flits in the switch 222. Therefore, the BTD(i) can be expressed as the product of an occupied buffer size B_{DR}(i) (i.e., the number of previous flits on the input buffer(i) 221 for downstream routers) and the RST, which is given by

BTD(i)=B_{DR}(i)×RST. (2)

The OCD(i) represents the average port-acquisition delay met by incoming flit due to the contention with other packets. If the incoming flit receives a failed output request, it must be blocked and then wait for a grant from the switch allocator. That is, the flit needs to wait for the packets that are in the other input buffers of the same router to pass. Therefore, the length of OCD(i) depends on two factors: a) the channel transfer delay of the packets in the other input buffers, and b) the contention probability between input channels. Namely, OCD(i) can be expressed as the expected channel transfer delay of competing packets in the other input buffers, which is a function of BTD(j) and contention probability (cᵢⱼₒ), and can be given by

OCD(i)=Σ_{j=1,j≠i}^{NCh}cᵢⱼₒBTD(j),

jϵ{north,east,south,west}, (3)

where the term NCh denotes the number of channels in a router (e.g., for 2-D mesh, NCh=5 directions), and the coefficient cᵢⱼₒ represents the contention probability between input channels i and j; that is, cᵢⱼₒ is the probability that packets from input channels i and j compete for a common output o. It can be expressed as

$${C}_{ijo} = \{ \begin{matrix}{f}_{io} \times {f}_{jo} , i \neq j \\ 0 , i = j\end{matrix} , \qquad ( 4 )$$

where fᵢₒ and fⱼₒ represent the probabilities of the presence of the packets in the input buffers (i) and (j) both toward the input buffer (o), respectively. Besides, since an incoming packet cannot be competed with itself, cᵢⱼₒ is 0 when i is equal to j.

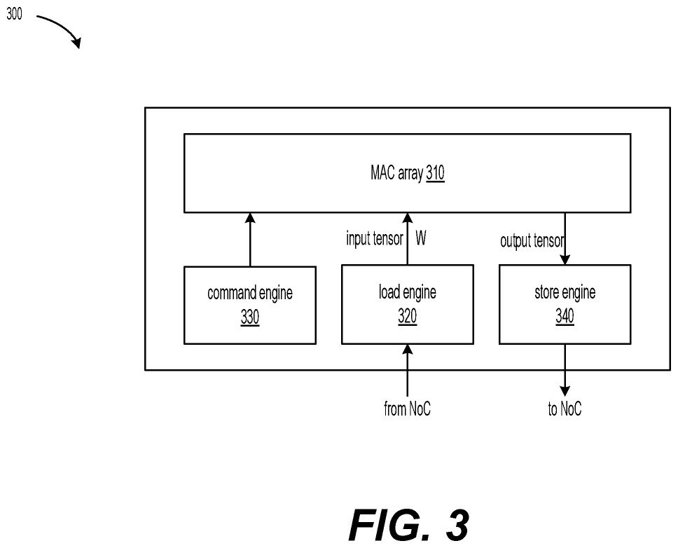

FIG. 3 is a block diagram of an exemplary DLA core 300 according to some embodiments of the present disclosure. For example, the DLA core 300 can include a multiply-accumulate (MAC) array 310 that may include one or more MAC units, a load engine 320 coupled to the MAC array 310 that receives tensor data from other cores of a NoC and input the tensor data to the MAC array 310, a command engine 330 coupled to the MAC array 310 that is configured to control the MAC array 310 to perform a variety of operations on the input tensor data, and a store engine 340 coupled to the MAC array 310 that receives the tensor data that are processed and output from the MAC array 310 and transfers the processed tensor data to other cores of the NoC. It takes a DLA core (k) a core latency L_{cores}(k) to process and output the tensor data, which is equal to the computing load CLₖ of the DLA core (k) divided by the number of MAC operations (or MAC units) in the DLA core (k), and is expressed as

$${L}_{cores} ( k ) = \frac{{CL}_{k}}{MAC} . \qquad ( 5 )$$

The energy model of an NoC, e.g., the NoC 110, can be expressed by

E_{NoC}=P_{buffering}×Σ_{kϵID}_{ᵣₒᵤₜₑᵣ}Σ_{iϵID}_{ₚₒᵣₜ}(BCT+BTD(i,k)+OCD(i,k)×Gᵢ+(P_{switching}×Σ_{kϵID}_{ᵣₒᵤₜₑᵣ} RST(k) (6)

where P the power of input buffers, e.g., the input buffers 221, k is the number of routers in the NoC, i is the number of ports that each of the router has, P_{switching} is the power of a switch, e.g., the switch 222, and Gᵢ indicates whether an input buffer is gated, e.g., “0” indicating that the input buffer is off when no flit will be forwarded thereto and “1” indicating that the input buffer is on when an incoming flit is forwarded from a neighboring router.

The energy model of multiple cores, e.g., the DLA cores 300, can be expressed by

$${E}_{cores} = {\sum }_{k ∈ {ID}_{core}} {P}_{computing , k ( v , {f}_{core} )} \times \frac{{CL}_{k}}{MAC \times {f}_{core}} , \qquad ( 7 )$$

wherein P_{computing, k} is the power of a computing DLA core, k is the number of DLA cores in an NoC, and v and f_{core} are the operating voltage and frequency of the DLA core, respectively.

According to the present disclosure, a goal is to minimize the E_{NoC} energy by considering the router latency L(i), which consists the channel transfer delay (BCT+BTD(i)) and the switch delay (RST+OCD(i)). In an embodiment, it is assumed that a packet passes through a routing path that has a hop count k, and

$$\begin{matrix}min ( {E}_{NoC} ) = min ( {\sum }_{k ∈ {ID}_{router}} {\sum }_{i ∈ {ID}_{port}} ( BTD ( i , k ) + OCD ( i , k ) \times \\ {G}_{i} ) + {\sum }_{k ∈ {ID}_{router}} RST ( k ) ) \\ = min ( {\sum }_{k ∈ {ID}_{router}} ( {\sum }_{i ∈ {ID}_{port}} ( {B}_{DR} ( i , k ) \times RST + \\ {\sum }_{j = 1 , j \neq i}^{NCh} {c}_{ijo} BTD ( i , j , k ) \times {G}_{i} ) + K \times RST ) \\ = min ( RST \times {\sum }_{k ∈ {ID}_{router}} {\sum }_{i ∈ {ID}_{port}} ( ( {B}_{DR} ( i , k ) + \\ {\sum }_{j = 1 , j \neq i}^{NCh} {c}_{ijo} BTD ( j , k ) \times {G}_{i} ) + K ) \\ = min ( \frac{1}{μ} {\sum }_{k ∈ {ID}_{router}} {\sum }_{i ∈ {ID}_{port}} ( ( {B}_{DR} ( i , k ) + \\ {\sum }_{j = 1 , j \neq i}^{NCh} {c}_{ijo} BTD ( j , k ) \times {G}_{i} ) )\end{matrix} , \qquad ( 8 )$$

where k is a minimal routing that is constant.

Therefore, the objective function of the NoC energy can be expressed by

$$min ( \frac{1}{μ} {\sum }_{k ∈ {ID}_{router}} {\sum }_{i ∈ {ID}_{port}} {B}_{eff} ( i , k ) \times {G}_{i} ) , \qquad ( 9 )$$

where the effective buffer length B_{eff}(i, k) can be expressed by

B_{eff}(i,k)=B_{DR}(i,k)+Σ_{j=1,j≠i}^{NCh}cᵢⱼₒBTD(j,k)=α×B_{DR}(i,k) (10)

where α≥1. For example, α=1 indicates that no contention occurs, while α>1 indicates that contention occurs. Therefore, if there is no channel congestion (or buffer occupancy) occurring in the NoC, which indicates that B_{DR}(i, j) is very small and can be ignored,

min(E_{NoC})˜min(Σ_{kϵID}_{ᵣₒᵤₜₑᵣ}Σ_{iϵID}_{ₚₒᵣₜ}Σ_{j=1,j≠i}^{NCh}cᵢⱼₒBTD(j,k)×Gᵢ). (11)

In such a scenario, only buffer gating control and contention-free switching shall be considered in order to minimize the energy consumption of the NoC. For example, if there is no buffer occupancy occurs in an NoC, some idle ports of the routers of the NoC can be turned off by pruning the clocks when no flits will be forwarded thereto from neighboring routers. As another example, the contention-free switching can be realized by an application-specific routing algorithm (APSRA) disclosed by Palesi et al. in “Application specific routing algorithms for networks on chip,” IEEE Transactions on Parallel and Distributed Systems, vol. 20, no. 3, 2008. On the contrast, if buffer occupancy does occur in the NoC, which indicates that B_{DR}(i, j) is significant and cannot be ignored,

min(E_{NoC})˜min(Σ_{kϵID}_{ᵣₒᵤₜₑᵣ}Σ_{iϵID}_{ₚₒᵣₜ}B_{eff}(i,k)). (12)

In such a scenario, adaptive routing algorithms can be further used to avoid deadlock and livelock of the NoC. Adaptive routing algorithms can be divided into partially adaptive routing algorithms and fully adaptive routing algorithms. Adaptive routing algorithms can also be classified as congestion-oblivious algorithms and congestion-aware algorithms based on whether their selection functions consider the output channel statuses.

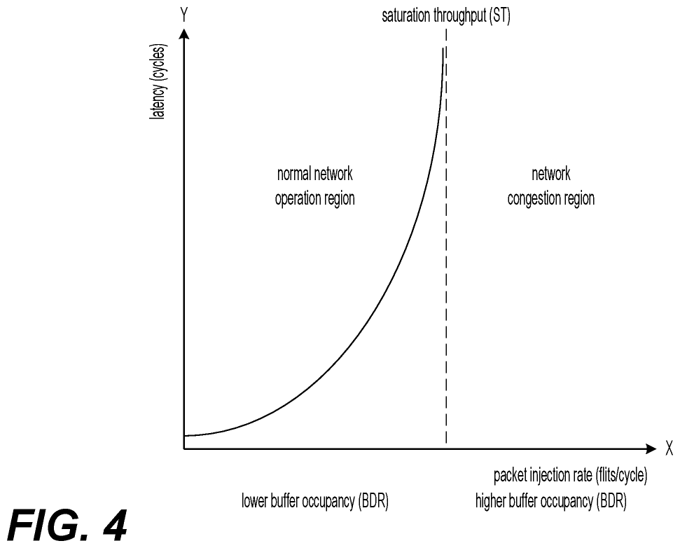

FIG. 4 is a graph that is used to evaluate the performance of an NoC, where X-axis represents packet injection rate (flits/cycle) of the NoC, and Y-axis represents the latency (cycles) of the NoC. It can be seen in FIG. 4 that as the packet injection rate is getting higher and higher, e.g., moving from a lower buffer occupancy (BDR) region toward a higher BDR region, the latency becomes greater and greater, and as the packet injection rate is very close to the saturation throughput (ST) of the NoC, i.e., the maximum data rate (e.g., in bits per second) that the NoC can accept per input port, the latency will be approaching indefinite and some channels of the NoC become saturated.

An ideal throughput θ_{ideal} of an NoC can be defined as an input bandwidth that saturates a bottleneck channel, and be expressed by

$${θ}_{ideal} = \frac{b}{{γ}_{max}} , \qquad ( 13 )$$

where b is an input bandwidth of a bottleneck channel of the NoC that carries the largest fraction of the traffic of the topology of the NoC, and γₘₐₓ, i.e., the maximum channel load, is determined by the bottleneck channel. When the offered traffic reaches the throughput of the NoC, the load on this bottleneck channel will be equal to the channel bandwidth b.

In general, the load on the bisection channels of a network can provide a lower bound on γₘₐₓ, which can in turn determine an upper bound on the best throughput. For uniform traffic, half of the traffic, i.e.,

$$\frac{N}{2}$$

packets, must cross the bisection channels. The best throughput can occur when input packets are distributed evenly across the bisection channels. Therefore, the load on each bisection channel γ_{b} is at least

$${γ}_{max} \geq {γ}_{b} = \frac{N}{2 {B}_{C}} , \qquad ( 14 )$$

where B_{C} is the number of the bisection channels. Combining equations (13) and (14) can get an upper bound on the ideal throughput θ_{ideal} as

$${θ}_{ideal} \leq \frac{2 {bB}_{C}}{N} = \frac{2 {B}_{B}}{N} . \qquad ( 15 )$$

The traffic bound can be expressed by

$${γ}_{max} \geq \frac{{\sum }_{p ∈ {ID}_{packet}} {H}_{p}}{C} = \frac{{NH}_{avg}}{C} , \qquad ( 16 )$$

where H is the number of routers in the NoC, and C is the number of the network channels. For example, in a k-ary, n-mesh network, e.g., a 2D 4×4 mesh (i.e., k=4 and n=2),

$$ST = min ( \frac{2 b \frac{2 N}{k}}{N} , \frac{b ( 2 n ( k - 1 ) k )}{{NH}_{avg}} ) . \qquad ( 17 )$$

According to the present disclosure, different communication-level energy saving strategies or schemes for an application running on a network, e.g., a DNN, that will be mapped to an NoC can thus be determined by referring to equations (17), (11) and (12). As shown in FIG. 4, in the normal operation region of the NoC, where the traffic of an application running on a DNN that is mapped to the NoC is less than the throughput of the NoC, which indicates that channel congestion or buffer occupancy is not likely to occur, a first routing scheme can be employed, which may include turning off some idle ports of the routers of the NoC and using the APSRA for contention-free switching, in order to minimize the energy consumption of the NoC. By contrast, in the network congestion region, where the traffic of the application is greater than the throughput of the NoC, which indicates that the channel congestion or buffer occupancy does occur, a second routing scheme can be employed, which may include using an adaptive routing algorithm in order to avoid deadlock and livelock of the NoC.

As mentioned previously, the tensor data input to the layers of a DNN can be partitioned into XY-partition tiles and/or K-partition tiles, which may be different in sizes. Specifically, the bandwidth requirement of the DNN traffic can depend on dataflow and tiling, and be expressed by

$${BW}_{DNN traffic} = \frac{{\sum }_{l ∈ ID \_ TIile} {Act}_{l} + Wgt}{{L}_{target}} , for XY - partition , \qquad ( 18 )$$

$${BW}_{DNN traffic} = \frac{Act + {\sum }_{l ∈ ID \_ Tile} {Wgt}_{l}}{{L}_{target}} , for K - partition . \qquad ( 19 )$$

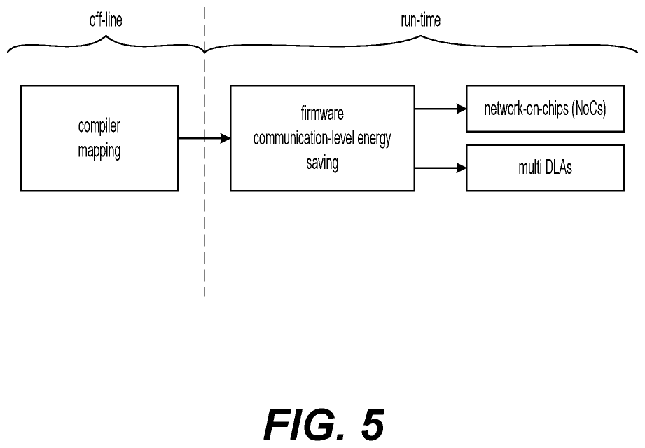

As a designer generally has an in-depth knowledge of an application that he is about to run on a network, e.g., a DNN, and the throughput information of an NoC on which the DNN is mapped, he can decide on how to partition the tensor data of the layers of the DNN and how to select a routing scheme accordingly. For example, the knowledge and the information can be used by an off-line compiler to generate firmware, which may relate to communication-level energy saving, for the NoC, e.g., multi-DLAs, to execute at run-time, as shown in FIG. 5.

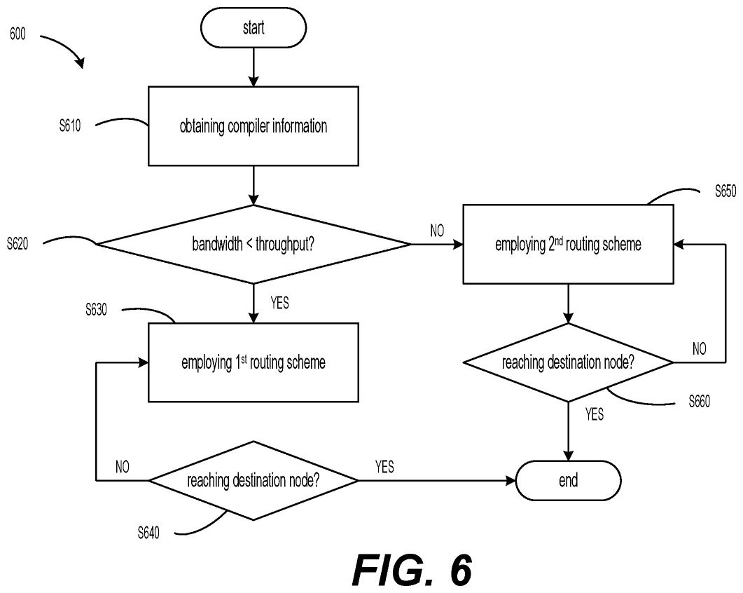

FIG. 6 is a flow chart of an exemplary method 600 according to some embodiments of the present disclosure. The method 600 can be used to select a routing scheme for an application run on a network, e.g., a DNN, that is mapped to an NoC. In various embodiments, some of the steps of the method 600 shown can be performed concurrently or in a different order than shown, can be substituted by other method steps, or can be omitted. Additional method steps can also be performed as desired. Aspects of the method 600 can be implemented by a compiler, for example.

At step S610, compiler information is obtained. In an embodiment, the compiler information can include the throughput of the NoC and the bandwidth requirement of the DNN traffic, which may depend on dataflow and tiling, including, for example, weights, biases, kernels and activation functions of the layers of the DNN.

At step S620, it is determined whether the bandwidth of the DNN traffic is less than the throughput of the NoC. For example, the input bandwidth of a bottleneck of the DNN can be determined as to whether it is less than the throughput of the NoC. If the bandwidth of the DNN traffic is less than the throughput of the NoC, the method 600 proceeds to step S630; otherwise, the method 600 proceeds to step S650,

At step S630, a first routing scheme is selected. The method 600 proceeding to step S630 indicates that the bandwidth of the DNN traffic is less than the throughput of the NoC, which indicates that channel congestion or buffer occupancy is not likely to occur. Therefore, contention-free switching and buffer gating control can be employed in order to minimize the energy consumption of the NoC. For example, if there is no buffer occupancy occurring in the NoC, some idle ports of the routers of the NoC can be turned off by pruning the clocks when no flits will be forwarded thereto from neighboring routers. As another example, the contention-free switching can be realized by using an APSRA.

At step S640, it is determined whether the destination node is reached. If the destination node is not reached yet, the method 600 returns to step S630, employing the first routing scheme to process the remaining nodes; otherwise, the method 600 ends.

At step S650, a second routing scheme is selected. The method 600 proceeding to step S650 indicates that the bandwidth of the DNN traffic is greater than the throughput of the NoC, which indicates that channel congestion or buffer occupancy does occur. Therefore, adaptive routing algorithms, e.g., partially adaptive routing algorithms and fully adaptive routing algorithms or congestion-oblivious algorithms and congestion-aware algorithms, can be selected, in order to avoid deadlock and livelock of the NoC.

At step S660, it is determined whether the destination node is reached. If the destination node is not reached yet, the method 600 returns to step S650, employing the second routing scheme to process the remaining nodes; otherwise, the method 600 ends.

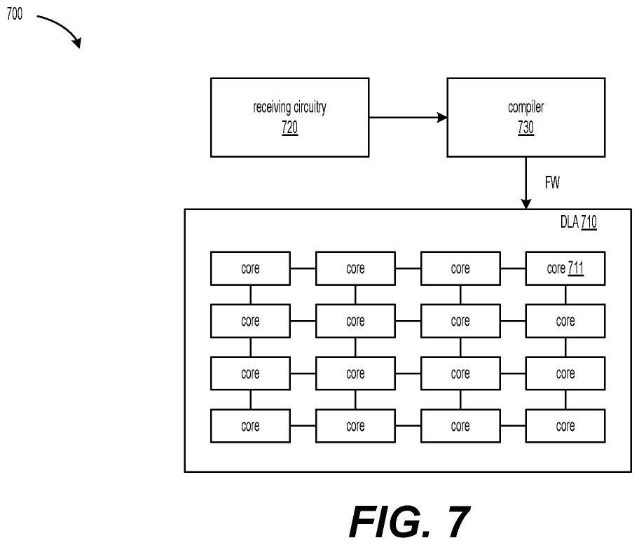

FIG. 7 is a functional block diagram of an exemplary apparatus 700 according to some embodiments of the present disclosure. In an embodiment, the apparatus 700 can be an electronic device, such as a mobile phone. In some embodiments, the apparatus 700 can be used to implement the method 600.

In an embodiment, the apparatus 700 can include a receiving circuitry 720, a compiler 730 coupled to the receiving circuitry 720, and a DLA 710 coupled to the compiler 730. The receiving circuitry 720 can receive compiler information for the compiler 730 to generate firmware FW that the DLA 710 can execute at run-time. For example, the compiler information can include the throughput of an NoC implemented by the DLA 710 and the bandwidth requirement of DNN traffic on which an application is about to be run. In an embodiment, the bandwidth requirement of DNN traffic may depend on dataflow and tiling, including, for example, weights, biases, kernels and activation functions of the layers of the DNN.

In an embodiment, the compiler 730 can determine a routing scheme based on the compiler information, and generate the firmware FW accordingly. For example, when determining that the bandwidth of the DNN traffic is less than the throughput of the NoC, the compiler 730 can generate the firmware FW that relates to contention-free switching and buffer gating control, in order to minimize the energy consumption of the NoC. As another example, when determining that the bandwidth of the DNN traffic is greater than the throughput of the NoC, the compiler 730 can generate the firmware FW that relates adaptive routing algorithms, in order to avoid deadlock and livelock of the NoC.

In an embodiment, the DLA 710 can include a plurality of DLA cores 711 in which the NoC is utilized. The DLA cores 711 can execute the firmware FW generated by the compiler 730 at run-time.

While aspects of the present disclosure have been described in conjunction with the specific embodiments thereof that are proposed as examples, alternatives, modifications, and variations to the examples may be made. Accordingly, embodiments as set forth herein are intended to be illustrative and not limiting. There are changes that may be made without departing from the scope of the claims set forth below.

What is claimed is:

1. A method for controlling a processing device to execute an application that runs on a neural network (NN), the processing device including a plurality of processing units arranged in a network-on-chip (NoC) architecture, comprising:
obtaining compiler information relating the application and the NoC;
controlling the processing device to employ a first routing scheme to process the application when the compiler information does not meet a predefined requirement; and
controlling the processing device to employ a second routing scheme to process the application when the compiler information meets the predefined requirement.

2. The method of claim 1, wherein the predefined requirement includes channel congestion occurring in the NoC.

3. The method of claim 2, wherein the compiler information includes bandwidths of channels of the NN and throughput of the NoC.

4. The method of claim 3, wherein the first routing scheme includes buffer gating control and contention-free switching.

5. The method of claim 3, wherein the second routing scheme includes an adaptive routing algorithm.

6. The method of claim 3, wherein the bandwidths of the channels of the NN depend on partitioning of tensor data of the application input to layers of the NN.

7. The method of claim 6, wherein the tensor data are partitioned into XY-partition tiles or K-partition tiles.

8. The method of claim 1, wherein the NN includes a deep NN (DNN).

9. The method of claim 1, wherein the processing device is a deep learning accelerator (DLA).

10. An apparatus, comprising:
receiving circuitry configured to receive compiler information;
a compiler coupled to the receiving circuitry, the compiler configured to determine a routing scheme and generate firmware; and
a processing device coupled to the compiler, the processing device configured to execute, based on the firmware, an application that runs on a neural network (NN) and including a plurality of processing units that are arranged in a network-on-chip (NoC) architecture,
wherein the processing device employs a first routing scheme to process the application when the compiler information does not meet a predefined requirement, and
the processing device employs a second routing scheme to process the application when the compiler information meets the predefined requirement.

11. The apparatus of claim 10, wherein the predefined requirement includes channel congestion occurring in the NoC.

12. The apparatus of claim 11, wherein the compiler information includes bandwidths of channels of the NN and throughput of the NoC.

13. The apparatus of claim 12, wherein the first routing scheme includes buffer gating control and contention-free switching.

14. The apparatus of claim 12, wherein the second routing scheme includes an adaptive routing algorithm.

15. The apparatus of claim 12, wherein the bandwidths of the channels of the NN depend on partitioning of tensor data of the application input to layers of the NN.

16. The apparatus of claim 15, wherein the tensor data are partitioned into XY-partition tiles or K-partition tiles.

17. The apparatus of claim 10, wherein the NN includes a deep NN (DNN).

18. The apparatus of claim 10, wherein the processing device is a deep learning accelerator (DLA).
